(19) United States
(12) Patent Application Publication
(10) Pub. No.: US 2017/0123617 A1
(43) Pub. Date: May 4, 2017

(54) PICTURE LOADING APPARATUS AND METHOD

(71) Applicants: BEIJING QIHOO TECHNOLOGY COMPANY LIMITED, Beijing (CN); QIZHI SOFTWARE (BEIJING) COMPANY LIMITED

(72) Inventors: Huaqiang ZHAO, Beijing (CN); Pengfei WANG, Beijing (CN)

(21) Appl. No.: 15/129,341

(22) PCT Filed: Dec. 29, 2014
(86) PCT No.: PCT/CN2014/095392

§ 371 Date: Sep. 26, 2016

(30) Foreign Application Priority Data
Mar. 26, 2014 (CN) 201410116592.3

(51) Int. Cl. G06F 3/0485; H04L 29/08

(52) U.S. Cl. CPC G06F 3/0485; H04L 67/10; H04L 67/02; H04L 67/42

(57) ABSTRACT

The invention discloses a picture loading apparatus comprising: a first judgment module configured to judge whether it is needed to request a server for downloading a picture; a request module configured to request the server for downloading a picture when the first judgment module determines that it is needed to request the server for downloading a picture; and a loading module configured to receive a picture downloaded from the server and load it to a browser. In addition, the invention further provides a picture loading method. By utilizing the picture loading apparatus and method of the invention, it can request downloading and loading a picture when it is judged that a user needs to view the picture, without the need for downloading all the pictures on a webpage, thereby reducing the interaction with the server and reducing the occupancy of CPU resources. Further, when a picture being downloaded or loaded is being scrolled away from a current display interface, the downloading or loading of the picture may be cancelled, thereby further reducing the interaction with the server and the occupancy of the CPU resources.

### FIELD OF THE INVENTION

The invention relates to internet technologies, and in particular, to a picture loading apparatus and method.

### BACKGROUND OF THE INVENTION

Nowadays, when a browser is displaying a webpage, it will generally request a server for downloading a picture to be displayed in a current display interface of the browser and then load and display it in the display interface. When a user continues to scroll up or down the page, it continues to request the server for downloading a picture to be displayed and to appear in the current display interface. However, when the user scrolls the webpage rapidly and the picture has not yet been downloaded from the server, the display interface will present a state in which the picture is not opened or a state in which it is being opened gradually, and the user needs to keep waiting for the picture to be opened bit by bit, which makes the user experience bad.

Additionally, when the user scrolls the page very rapidly for the purpose of just browsing the page rapidly or wanting to view the bottommost picture or information in the page, if the server is requested for downloading a picture that passes the current display interface each time the page passes the current display interface, a lot of requests must be sent to the server in a short period of time, but these requests are unnecessary in fact. Such a download mode will increase the work load of the server on one hand, and will affect the display speed of a picture which really needs to be displayed on the browser on the other hand.

### SUMMARY OF THE INVENTION

In view of the above problem, the invention is proposed to provide a picture loading apparatus and method, which overcome the above problem or at least partly solve the above problem.

According to an aspect of the invention, there is provided a picture loading apparatus comprising: a first judgment module configured to judge whether it is needed to request a server for downloading a picture; a request module configured to request the server for downloading a picture when the first judgment module determines that it is needed to request the server for downloading a picture; and a loading module configured to receive a picture downloaded from the server and load it to a browser.

According to another aspect of the invention, there is provided a picture loading method comprising: judging whether it is needed to request a server for downloading a picture; requesting the server for downloading a picture when it is judged that it is needed to request the server for downloading a picture; and receiving a picture downloaded from the server and loading it to a browser.

According to still another aspect of the invention, there is provided a computer program comprising a computer readable code which causes a computing device to perform any of the picture loading methods, when said computer readable code is running on the computing device.

According to yet still another aspect of the invention, there is provided a computer readable medium storing therein the computer program as described above.

By utilizing the picture loading apparatus and method of the invention, it can request downloading and loading a picture when it is judged that a user needs to view the picture, and at most the pictures of the current screen and a next screen or next two screens will be requested to be downloaded and loaded, without the need for downloading all the pictures on a webpage, thereby reducing the interaction with the server and reducing the occupancy of CPU resources. Further, when a picture being downloaded or loaded is scrolled away from a current display interface, the downloading or loading of the picture may be cancelled, thereby further reducing the interaction with the server and the occupancy of the CPU resources.

The above description is merely an overview of the technical solutions of the invention. In the following particular embodiments of the invention will be illustrated in order that the technical means of the invention can be more clearly understood and thus may be embodied according to the content of the specification, and that the foregoing and other objects, features and advantages of the invention can be more apparent.

### BRIEF DESCRIPTION OF THE DRAWINGS

Various other advantages and benefits will become apparent to those of ordinary skills in the art by reading the following detailed description of the preferred embodiments. The drawings are only for the purpose of showing the preferred embodiments, and are not considered to be limiting to the invention. And throughout the drawings, like reference signs are used to denote like components. In the drawings:

FIG. 1 shows a block diagram of a picture loading apparatus according to an embodiment of the invention;

FIG. 2 shows a flow diagram of a picture loading method according to another embodiment of the invention;

FIG. 3 shows a flow diagram of an example of the picture loading method according to an embodiment of the invention;

FIG. 4 shows schematically a block diagram of a computing device for performing a picture loading method according to the invention; and

FIG. 5 shows schematically a storage unit for retaining or carrying a program code implementing a picture loading method according to the invention.

### DETAILED DESCRIPTION OF THE INVENTION

In the following the invention will be further described in connection with the drawings and the particular embodiments.

When a webpage is displayed on a browser of a client, the browser will download from a server the content of the webpage, for example, a text and/or picture on the webpage, and then load it to the browser for display. The invention mainly relates to loading of a picture in a webpage on a browser.

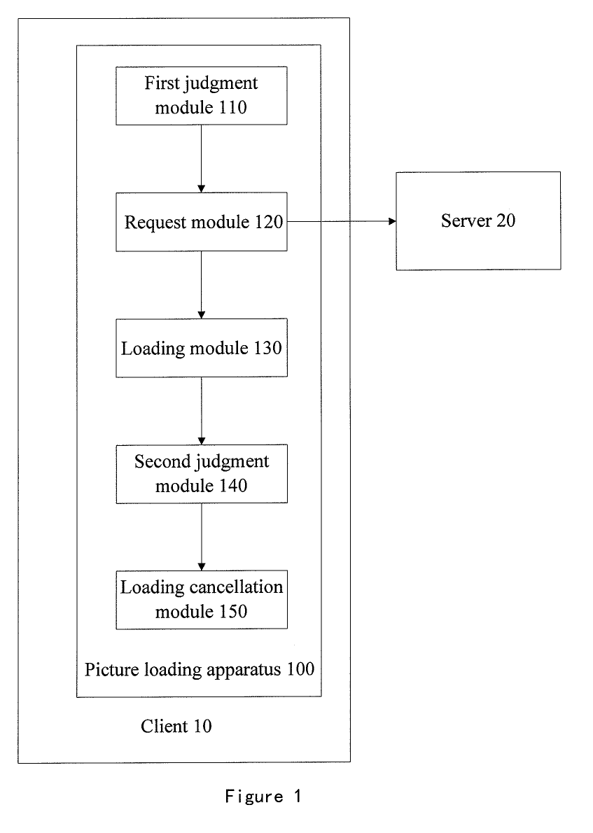

FIG. 1 shows a block diagram of a picture loading apparatus according to an embodiment of the invention. As shown in FIG. 1, the picture loading apparatus 100 of the invention comprises a first judgment module 110, a request module 120 and a loading module 130.

Therein, the first judgment module 110 is configured to judge whether it is needed to request a server for downloading a picture. In particular, the first judgment module 110 may judge whether to request the server for downloading a picture in a webpage according to the dwell time of the picture on the current display interface of a browser. In general, when a user is browsing a webpage on the browser, the speed of the operation of scrolling the webpage will be different due to his needs for browsing the webpage being different. For example, when the user only wants to know what content the webpage generally relates to, he will mainly browse the content of the homepage of the webpage, and then may scroll the webpage very rapidly to a certain part in the middle of the webpage or to the bottom of the webpage, and at this point, it is only needed to download the picture of the homepage of the webpage from the server. When the webpage is scrolled rapidly, though pictures displayed in the current display interface of the browser pass the current display interface, the user does not want to view these pictures carefully, and therefore, there is no need to request downloading these pictures from the server. However, when the user is also interested in the content other than the homepage of the webpage, he will scroll the webpage slowly, and at this time, when a picture in the webpage appears in the current display interface of the browser, it is necessary to request the server for downloading the picture.

To this end, a predetermined threshold may be set for the dwell time of a picture in a webpage on the current display interface of the browser according to experience. When the dwell time of a picture in a webpage on the current display interface of the browser is greater than the predetermined threshold, the first judgment module 110 determines to request the server for downloading the picture; and when the dwell time of a picture in a webpage on the current display interface of the browser is less than the predetermined threshold, the first judgment module 110 determines not to request the server for downloading the picture.

As such, through the judgment of the first judgment module 110, it may be determined whether to request the server for downloading a picture. For a case in which there is no need to request the server for downloading a picture, the number of requests to the server, the time in downloading the picture from the server, and the time in loading the picture in the browser may be reduced, thereby the speed of browsing a webpage may be increased, and the user experience may be improved.

The request module 120 is configured to request the server for downloading a picture when the first judgment module 110 determines that it is needed to request the server for downloading a picture.

For example, when the dwell time of a picture in a webpage on the current display interface of the browser is greater than the predetermined threshold, the first judgment module 110 determines to request the server for downloading the picture. At this point, the request module 120 may request the server for downloading the picture displayed in the current display interface.

Optionally, the request module 120 may also request the server for downloading the picture displayed in the current display interface and a picture of a next screen to be displayed in the current display interface. Since a user will scroll up or down a webpage when browsing the webpage, adoption of such a way may request in advance pictures to be displayed next on the current display interface of the browser, rather than request the server for downloading the pictures until these pictures appear on the current display interface of the browser. As such, the speed at which the browser displays a picture of a webpage may be further increased.

The loading module 130 is configured to receive a picture downloaded from a server and load it to a browser. When the request module 120 requests the server 20 for downloading a picture, the server 20 will transmit a corresponding picture to the client 10 according to the request from the request module 120, and at this time, the loading module 130 will receive the picture transmitted from the server 20 and load it to the browser for display. When the request module 120 requests the server 20 for downloading the picture displayed on the current display interface of the browser and a picture of a next screen to be displayed on the current display interface of the browser, the server 20 will, according to the request from the request module 120, transmit the picture displayed on the current display interface and the picture of the next screen to be displayed on the current interface of the browser to the loading module 130, and at this time, the loading module 130 will load both the picture of the current screen and the picture of the next screen to the browser for display.

In addition, optionally, when the request module 120 requests the server 20 for downloading a picture, in order to enable the user to see the picture as soon as possible, instead of waiting for a long time when browsing the picture, the server 20 may extract thumbnails of the picture of multiple sizes, respectively. Here, the size of a thumbnail is generally obtained by extracting it from the original picture according to the resolution, and the size of a thumbnail of a picture with a low resolution is small. Here, how many thumbnails are extracted is not defined, which may be determined as needed. Then, the server 20 transmits the thumbnails of different sizes to the client 10 in batches from a small size to a large size. The smaller the thumbnail is, the smaller the network data is, and more quickly the speed of the transmission to the client is. For example, a picture of about 1 KB may be transmitted to the client instantaneously. As such, the loading module 130 may first rapidly load a thumbnail with a relatively small size to the browser for display, and while the loading module 130 is loading the thumbnail with a relatively small size, the server 20 is transmitting a thumbnail with a relatively large size to the client. Thus, after loading the thumbnail with a relatively small size, the loading module 130 may load the thumbnail with a relatively large size at once, wherein the resolution of the thumbnail with a relatively large size will be higher than that of the thumbnail with a relatively small size, which makes it looks clearer. Thus, by analogy, the original copy of the picture is eventually displayed on the browser. For example, in a typical environment, if the server extract thumbnails of three different sizes from small to large (called a small sized thumbnail, a middle sized thumbnail, and a large sized thumbnail for the time being), the small sized thumbnail may be seen at the client generally in less than 0.1 seconds, the clearer middle sized thumbnail and large sized thumbnail may be displayed at the client in turn in 0.2 seconds and 0.5 seconds, respectively, and the original picture generally needs 1.0 second to be displayed at the client. In this way, at the client, the user will see that the picture is gradually clearly displayed on the browser, which improves the user experience.

In the above, a description is made taking that the server extracts three sized thumbnails, i.e., a small sized thumbnail, a middle sized thumbnail and a large sized thumbnail as an example, however, the number of thumbnails extracted by the server is not limited to three sizes, and it may extract thumbnails of more sizes, such that the sizes of the thumbnails are divided more finely. However, the more the thumbnails are extracted, the more processing by the server there will be, which will occupy the resources of the server and affect its running speed. In particular, how many thumbnails of different sizes are extracted may be preset as required, which will not be defined here.

In addition, the picture loading apparatus 100 of the invention may further comprise a second judgment module 140 and a loading cancellation module 150. The second judgment module 140 is configured to judge whether a picture of the current screen is being scrolled away from the current display interface. The loading cancellation module 150 is configured to cancel downloading a picture of the current screen and a picture of a next screen from the server 20 and cancel loading the picture of the current screen and the picture of the next screen to the browser by the loading module 130, when the second judgment module 140 judges that the picture of the current screen is being scrolled away from the current display interface.

In general, there are two situations in which a user browses a webpage, the first one is to want to view content displayed on the current display interface, including a picture, and the second one is not to want to view content displayed on the current display interface, but simply pass it rapidly, or is to scroll away from the current screen immediately after viewing part of the content displayed on the current display interface. For the first situation, generally, the request module 120 requests downloading a picture of the current screen to be displayed on the current display interface and a picture of a next screen to be displayed on the current display interface from the server 20. The loading module 130 loads the downloaded pictures to the browser, and only after the user sees a picture on the display interface will he perform a scrolling operation to cause the picture of the current screen to leave the current display interface. Nevertheless, for the second situation, after viewing part or all of the picture of the current screen, the user does not want to view carefully the picture of each screen one screen after another, and therefore, after viewing the picture of a certain screen, to overview the content of the whole webpage, the user may scroll the webpage rapidly, then may randomly pause at a certain screen for a while for viewing, and then rapidly scroll the webpage again. When the user rapidly scrolls a webpage but does not intend to view the picture entering the current display interface, the webpage is generally scrolled relatively rapidly. At this point, the second judgment module 140 judges that the picture of the current screen is being scrolled away from the current display interface, and if, at this time, only part of the picture of the current screen is loaded onto the current display interface, the loading cancellation module 150 cancels loading others of the picture in the current screen which have not yet been loaded, and cancels downloading or loading for a picture of a next screen which is being downloaded or loaded.

For example, when the user rapidly scrolls a webpage immediately after viewing the homepage, or during the rapid scrolling, randomly pauses at a certain screen for viewing and then rapidly scrolls the page again, in fact, the user only wants to view a picture of the homepage or that screen where he pauses. In such a case, the user will not view a picture of a next screen, however, as described above, the actual situation is that when the user views the picture of the current screen, the picture of the next screen has already been requested to be downloaded or is being loaded, and at this point, the loading cancellation module 150 may cancel downloading the picture of the next screen and loading it onto the browser. As such, it can reduce the requests to the server, the downloading of pictures and the picture loading on the browser, thereby reducing interactions with the server, reducing occupancy of the CPU resource, and increasing the running speed of the browser.

In addition, when after viewing part of picture of the current screen on the current display interface, the user make the current screen to leave the current display interface at once and rapidly scrolls the page, the loading cancellation module 150 may not only cancel downloading or loading a picture of a next screen, but also can cancel downloading or loading a picture in the current screen which has not been loaded.

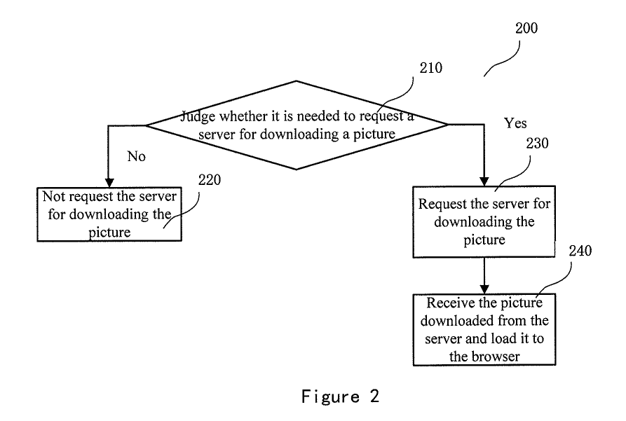

According to another aspect of the invention, there is further provided a picture loading method. FIG. 2 shows a flow diagram of a picture loading method according to an embodiment of the invention.

As shown in FIG. 2, the picture loading method 200 of the invention begins at step S210, at which it is judged whether it is needed to request a server for downloading a picture. In particular, it may be judged whether to request the server for downloading a picture in a webpage according to the dwell time of the picture on the current display interface. According to practical experience, a predetermined threshold is set for the dwell time of a picture on the current display interface. When the dwell time of a picture on the current display interface is greater than the predetermined threshold, it shows that the dwell time of the picture on the current display interface is relatively long and the user wants to view the picture. At this point, it is determined to request the server for downloading the picture, and it proceeds to step S230 to request the server for downloading the picture. When the dwell time of a picture on the current display interface is less than or equal to the predetermined threshold, it shows that the dwell time of the picture on the current display interface is relatively short, and it is judged that the client just scrolls the page rapidly and does not want to view the picture. At this point, it is determined not to request the server for downloading the picture, and it proceeds to step S220, at which the server is not requested for downloading the picture. When performing the operation of requesting the server for downloading a picture at the step S230, to increase the speed at which a picture in a webpage is displayed in a browser, it can request downloading a picture of the current screen and a picture on a next screen to be displayed on the current display interface of the browser, or also can request downloading a picture of the current screen and pictures on next two screens to be displayed on the current display interface of the browser. The invention does not define how many screens of pictures to be requested for downloading.

The above mentioned predetermined threshold is mainly determined according to experience, for example, set to be 1 second. That is, when the picture dwells on the current display interface for more than 1 second, it is determined that the user wants to browse the picture, and a thumbnail of the picture is downloaded from the server. Preferably, to make the user to see the picture as soon as possible, instead of waiting for a long time when browsing the picture, the server may extract thumbnails of the picture of multiple sizes, and divide the thumbnails of multiple sizes into several groups. The predetermined threshold may also be set more than one, for example, a first predetermine threshold, a second predetermined threshold (the second predetermined threshold is greater than the first predetermined threshold), etc. According to the dwell time of a picture on the current display interface, it is determined to request the server for downloading pictures of a different group. When multiple predetermined thresholds are set, the step S210 and the step S230 are performed multiple times. For example, it may be set to request downloading a small sized thumbnail and a middle sized thumbnail when a picture just enters the current display interface, and directly load the middle sized thumbnail immediately after the loading of the small sized thumbnail is completed. Here, both the small sized thumbnail and the middle sized thumbnail are thumbnails of a very small size, and may be rapidly downloaded from the server and loaded to the browser, and therefore generally the small sized thumbnail and the middle sized thumbnail are also requested to be downloaded from the server simultaneously. Starting from the time when the dwell time of the picture on the current display interface exceeds 1 second (i.e., the first predetermined threshold), a large sized thumbnail is requested to be downloaded, and starting from the time when the dwell time of the picture on the current display interface exceeds 2 seconds (i.e., the second predetermined threshold), a thumbnail of a larger size is requested to be downloaded, until the original picture is requested to be downloaded. After a request for downloading a picture is made to the server at the step S230, step S240 is performed to receive the picture downloaded from the server and load it to the browser, such that the picture is displayed on the browser. As described above, only when the server extracts a small sized thumbnail, a middle sized thumbnail and a large sized thumbnail of a picture to be downloaded, respectively and a predetermined threshold is set, namely, only when the dwell time of a picture on the current display interface is greater than the predetermined threshold, does the request for downloading the picture from the server begin. In such a case, the small sized thumbnail, the middle sized thumbnail, the large sized thumbnail and the original picture transmitted from the server are received in turn. Since the smaller the size of the picture is, the higher the speed of the download from the server is, thus, the small sized thumbnail may be very rapidly loaded to the browser and displayed. Still, at the same time when the small sized thumbnail is loaded, the middle sized thumbnail is further downloaded from the server. Thus, after loading the small sized thumbnail, the browser may load the middle sized thumbnail at once, wherein the middle sized thumbnail will look clearer than the small sized thumbnail. Thus, by analogy, the original copy of the picture is eventually loaded onto the browser. As described above, thumbnails of a picture extracted at the server are divided into several groups, and two predetermined thresholds are set, that is, a first predetermined threshold and a second predetermined threshold are set, wherein the second predetermined threshold is greater than the first predetermined threshold. When the dwell time of a picture on the current display interface is greater than the first predetermined threshold (e.g., 1 second), a large sized thumbnail is loaded; and when the dwell time of the picture on the current display interface is greater than the second predetermined threshold (e.g., 2 seconds), a thumbnail of a larger size is loaded. In such a way, the display effect of the picture seen by the user on the browser of the client will be that the picture is gradually clearly displayed on the browser, making the user experience to be good.

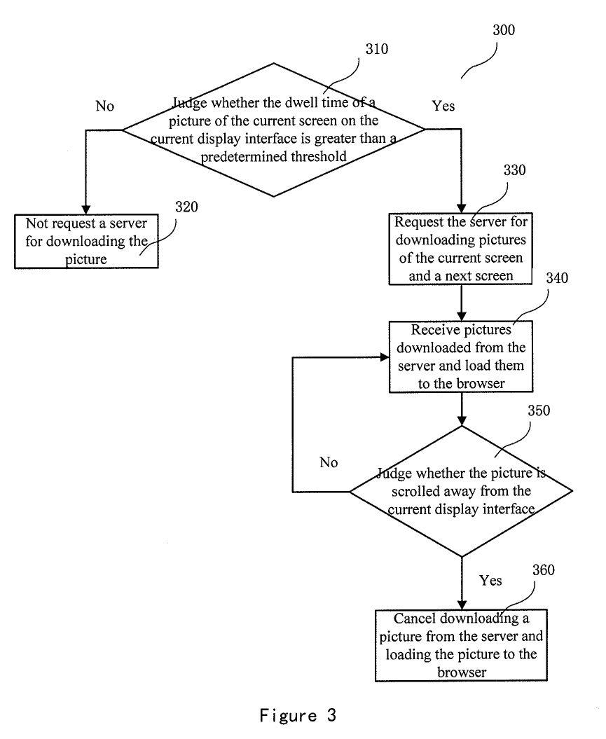

FIG. 3 shows a flow diagram of an example of the picture loading method according to the invention. As shown in FIG. 3, at step S310, it is judged whether the dwell time of a picture of the current screen on the current display interface is greater than a predetermined threshold. The predetermined threshold here is determined according to experience, for example, 1 second, etc. If the dwell time of the picture of the current screen on the current display interface is less than the predetermined threshold, it shows that the user just rapidly scrolls a webpage, and does not want to view the picture of the current screen. At this point, step S320 is performed to not to request a server for downloading the picture. If the dwell time of the picture of the current screen on the current display interface is greater than the predetermined threshold, it shows that the user is waiting for viewing the picture of the current screen, and at this point, step S330 is performed to request the server for downloading pictures of the current screen and a next screen. Of course, it can only request downloading the picture of the current screen, however, in order to make the loading of pictures onto a browser to be as continuous as possible, here, the server is requested not only for downloading the picture of the current screen, but also for downloading the picture of the next screen.

Next, step S340 is performed to receive pictures downloaded from the server and load them to the browser. The browser will receive the pictures requested to be downloaded from the server, load them and display them in turn. However, when the user decides not to carefully view a picture of each screen any more after viewing part or all of the picture of the current display screen, the user will rapidly scroll the webpage. However, at this time, part of the picture of the current screen or the picture of the next screen is being downloaded or loaded, but the user does not want to view it. To this end, at step S350, it is judged whether the picture is scrolled away from the current display interface. When the user rapidly scrolls to move away from the current screen and does not make the picture of the next screen to dwell on the current display interface during or after viewing the picture of the current screen, step S360 is performed to cancel downloading a picture from the server and loading the picture to the browser, that is, cancel downloading a picture from the server which is being downloaded and cancel loading a picture which is being loaded to the browser, which thereby may reduce such interaction operations as request to the server, downloading a picture from the server, and loading a picture to the browser, and thereby increase the running speed of the system.

When it is judged at the step S350 that the picture is not scrolled away from the current display interface, step S340 is performed to continue to receive a picture downloaded from the server and load it to the browser.

By utilizing the method of the invention, it can request downloading and loading a picture when it is judged that a user needs to view the picture, and at most the pictures of the current screen and a next screen or next two screens are requested to be downloaded and loaded, without the need for downloading all the pictures on a webpage, thereby reducing the interaction with the server and reducing the occupancy of CPU resources. Further, when after viewing part or all of the picture of the current screen, a user wants to leaf through a picture of other screen, a picture of the next screen may not be viewed any longer. At this point, although part of the picture of the current screen and the picture of the next screen have already been requested to the server for downloading, or are being downloaded, or are being loaded to the browser, these operations may all be cancelled, and the server is requested directly for downloading the picture of that screen which the user wants to view, which thereby may avoid some unnecessary downloading and loading, further reduce some interaction operations, and thereby further reduce the occupancy of the CPU resource.

In the specification provided herein, a plenty of particular details are described. However, it can be appreciated that an embodiment of the invention may be practiced without these particular details. In some embodiments, well known methods, structures and technologies are not illustrated in detail so as not to obscure the understanding of the specification.

Similarly, it shall be appreciated that in order to simplify the disclosure and help the understanding of one or more of all the inventive aspects, in the above description of the exemplary embodiments of the invention, sometimes individual features of the invention are grouped together into a single embodiment, figure or the description thereof. However, the disclosed methods should not be construed as reflecting the following intention, namely, the claimed invention claims more features than those explicitly recited in each claim. More precisely, as reflected in the following claims, an aspect of the invention lies in being less than all the features of individual embodiments disclosed previously. Therefore, the claims complying with a particular implementation are hereby incorporated into the particular implementation, wherein each claim itself acts as an individual embodiment of the invention.

It may be appreciated to those skilled in the art that modules in a device in an embodiment may be changed adaptively and arranged in one or more device different from the embodiment. Modules or units or assemblies may be combined into one module or unit or assembly, and additionally, they may be divided into multiple sub-modules or sub-units or subassemblies. Except that at least some of such features and/or procedures or units are mutually exclusive, all the features disclosed in the specification (including the accompanying claims, abstract and drawings) and all the procedures or units of any method or device disclosed as such may be combined employing any combination. Unless explicitly stated otherwise, each feature disclosed in the specification (including the accompanying claims, abstract and drawings) may be replaced by an alternative feature providing an identical, equal or similar objective.

Furthermore, it can be appreciated to the skilled in the art that although some embodiments described herein comprise some features and not other features comprised in other embodiment, a combination of features of different embodiments is indicative of being within the scope of the invention and forming a different embodiment. For example, in the following claims, any one of the claimed embodiments may be used in any combination.

Embodiments of the individual components of the invention may be implemented in hardware, or in a software module running on one or more processors, or in a combination thereof. It will be appreciated by those skilled in the art that, in practice, some or all of the functions of some or all of the components in a picture loading apparatus according to individual embodiments of the invention may be realized using a microprocessor or a digital signal processor (DSP). The invention may also be implemented as a device or apparatus program (e.g., a computer program and a computer program product) for carrying out a part or all of the method as described herein. Such a program implementing the invention may be stored on a computer readable medium, or may be in the form of one or more signals. Such a signal may be obtained by downloading it from an Internet website, or provided on a carrier signal, or provided in any other form.

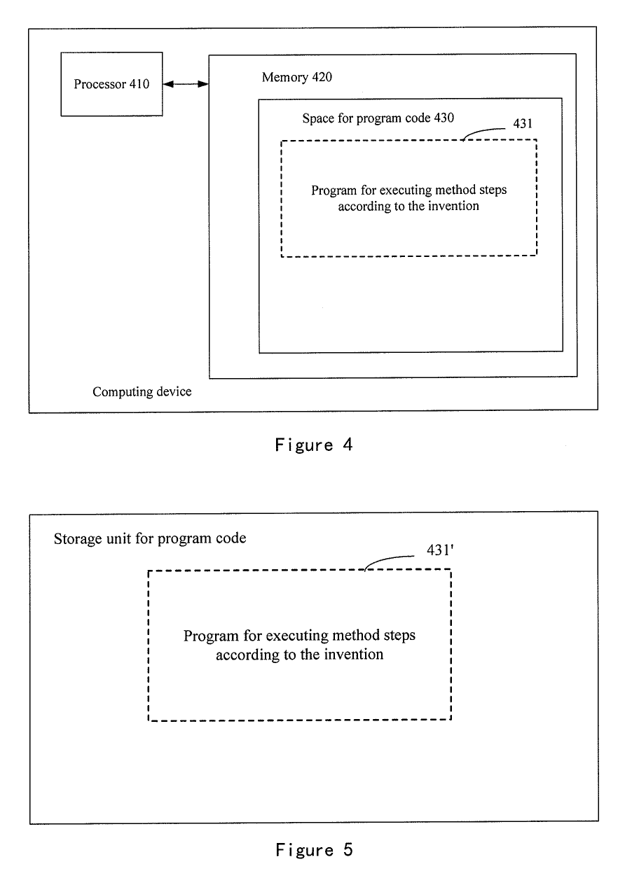

For example, FIG. 4 shows a computing device which may carry out a picture loading method according to the invention. The computing device traditionally comprises a processor 410 and a computer program product or a computer readable medium in the form of a memory 420. The memory 420 may be an electronic memory such as a flash memory, an EEPROM (electrically erasable programmable read-only memory), an EPROM, a hard disk or a ROM. The memory 420 has a memory space 430 for storing a program code 431 for carrying out any method step in the methods as described above. For example, the memory space 430 for a program code may comprise individual program codes 431 for carrying out individual steps in the above methods, respectively. The program codes may be read out from or written to one or more computer program products. These computer program products comprise such a program code carrier as a hard disk, a compact disk (CD), a memory card or a floppy disk. Such a computer program product is generally a portable or stationary storage unit as described in FIG. 5. The storage unit may have a memory segment, a memory space, etc. arranged similarly to the memory 420 in the computing device of FIG. 4. The program code may for example be compressed in an appropriate form. In general, the storage unit comprises a computer readable code 431′, i.e., a code which may be read by e.g., a processor such as 410, and when run by a computing device, the codes cause the computing device to carry out individual steps in the methods described above.

“An embodiment”, “the embodiment” or “one or more embodiments” mentioned herein implies that a particular feature, structure or characteristic described in connection with an embodiment is included in at least one embodiment of the invention. In addition, it is to be noted that, examples of a phrase “in an embodiment” herein do not necessarily all refer to one and the same embodiment.

It is to be noted that the above embodiments illustrate rather than limit the invention, and those skilled in the art may design alternative embodiments without departing the scope of the appended claims. In the claims, any reference sign placed between the parentheses shall not be construed as limiting to a claim. The word “comprise” or “comprising” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a unit claim enumerating several apparatuses, several of the apparatuses may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the invention. Therefore, for those of ordinary skills in the art, many modifications and variations are apparent without departing the scope and spirit of the appended claims. For the scope of the invention, the disclosure of the invention is illustrative, but not limiting, and the scope of the invention is defined by the appended claims.

1. A picture loading apparatus comprising:
a memory having instructions stored thereon;
a processor configured to execute the instructions to perform following operations:
judging whether it is needed to request a server for downloading a picture;
requesting the server for downloading a picture when it is needed to request the server for downloading a picture; and
receiving a picture downloaded from the server and loading it to a browser.

2. The apparatus as claimed in claim 1, wherein
the step of judging whether it is needed to request the server for downloading a picture comprises: judging whether to request the server for downloading a picture according to the dwell time of the picture on the current display interface of the browser.

3. The apparatus as claimed in claim 2, wherein
the step of judging whether to request the server for downloading a picture according to the dwell time of the picture on the current display interface of the browser comprises:
determining to request the server for downloading a picture when the dwell time of the picture on the current display interface is greater than a predetermined threshold; and determining not to request the server for downloading a picture when the dwell time of the picture on the current display interface is less than or equal to the predetermined threshold.

4. The apparatus as claimed in claim 1, wherein
the step of requesting the server for downloading a picture when it is judged that it is needed to request the server for downloading a picture comprises: requesting the server for downloading the picture displayed in the current display interface and a picture of a next screen to be displayed in the current display interface; and
the step of downloading a picture from the server and loading it based on the request sent to the server comprises: downloading the picture from the server and loading the picture displayed in the current display interface and the picture of the next screen to be displayed in the current display interface.

5. The apparatus as claimed in claim 1, wherein
the step of downloading a picture from the server and loading it based on the request sent to the server comprises: downloading thumbnails of the picture from a small size to a large size from the server in turn and load them in turn.

6. The apparatus as claimed in claim 4, further comprising:
after the step of downloading a picture from the server and loading it based on the request sent to the server, there is further comprised:
judging whether the picture of the current screen is being scrolled away from the current display interface; and
when it is judged that the picture is being scrolled away from the current display interface, cancelling downloading the picture and a picture of a next screen from the server and cancelling loading the picture and the picture of the next screen to the browser.

7. A picture loading method comprising:
judging whether it is needed to request a server for downloading a picture;
requesting the server for downloading a picture when it is judged that it is needed to request the server for downloading a picture; and
receiving a picture downloaded from the server and loading it to a browser.

8. The method as claimed in claim 7, wherein
the step of judging whether it is needed to request the server for downloading a picture comprises: judging whether to request the server for downloading a picture according to the dwell time of the picture on the current display interface of the browser.

9. The method as claimed in claim 8, wherein
the step of judging whether to request the server for downloading a picture according to the dwell time of the picture on the current display interface of the browser comprises:
determining to request the server for downloading a picture when the dwell time of the picture on the current display interface is greater than a predetermined threshold; and determining not to request the server for downloading a picture when the dwell time of the picture on the current display interface is less than or equal to the predetermined threshold.

10. The method as claimed in claim 7, wherein
the step of requesting the server for downloading a picture when it is judged that it is needed to request the server for downloading a picture comprises: requesting the server for downloading the picture displayed in the current display interface and a picture of a next screen to be displayed in the current display interface; and
the step of downloading a picture from the server and loading it based on the request sent to the server comprises: downloading the picture from the server and loading the picture displayed in the current display interface and the picture of the next screen to be displayed in the current display interface.

11. The method as claimed in claim 7, wherein
the step of downloading a picture from the server and loading it based on the request sent to the server comprises: downloading thumbnails of the picture from a small size to a large size from the server and loading them in turn.

12. The method as claimed in claim 10, wherein
after the step of downloading a picture from the server and loading it based on the request sent to the server, there is further comprised:
judging whether the picture of the current screen is being scrolled away from the current display interface; and when it is judged that the picture is being scrolled away from the current display interface, cancelling downloading the picture and a picture of a next screen from the server and cancelling loading the picture and the picture of the next screen to the browser.

13. (canceled)

14. A non-transitory computer readable medium having instructions stored thereon that, when executed by at least one processor, cause the at least one processor to perform following operations:
judging whether it is needed to request a server for downloading a picture;
requesting the server for downloading a picture when it is judged that it is needed to request the server for downloading a picture; and
receiving a picture downloaded from the server and loading it to a browser.
